(19) United States
(12) Patent Application Publication
(10) Pub. No.: US 2011/0077966 A1
(43) Pub. Date: Mar. 31, 2011

(54) ALLERGY ELECTRONIC MEDICAL RECORD SYSTEM AND METHOD

(75) Inventors: Alan B. Whitehouse, Augusta, GA (US); Christopher L. Vickery, Augusta, GA (US); Keith A. Lynn, Johnson, SC (US); Stephen W. Smith, Martinez, GA (US)

(73) Assignee: AUGUSTA E.N.T., P.C., Evans, GA (US)

(21) Appl. No.: 12/567,986

(22) Filed: Sep. 28, 2009

(51) Int. Cl. G06Q 50/00; G06F 17/30; G06F 17/40

(52) U.S. Cl. 705/3; 707/E17.044

(57) ABSTRACT

A method of managing information related to immunotherapy treatment in a computer system is provided. The computer system includes an input peripheral system for reading a computer-readable code and inputting the computer-readable code into the computer system. An antigen having a predetermined concentration is associated with a master code that is computer readable to at least identify the antigen and the concentration of the antigen associated with the master code. An antigen recipe to be administered to the patient during immunotherapy treatment is associated with an antigen recipe code that is computer readable to identify each antigen included in the antigen recipe that is to be administered to the patient. In response to receiving the master code read by the input peripheral system in communication with the computer system, the antigen and the concentration of the antigen are associated with the antigen recipe code.

### BACKGROUND OF THE INVENTION

1. Field of the Invention

This application relates generally to a method and apparatus for maintaining and presenting patient information, and more specifically to a computerized method and apparatus for associating a patient with antigen information and presenting said information to ensure reliable immunotherapy treatment of the patient.

2. Description of Related Art

Conventional immunotherapy treatment involves a patient visiting an allergist in response to experiencing what the patient believes to be an allergic reaction. The patient identifies the suspected antigen to the allergist that the patient suspects of causing the allergic reaction. The patient is then given a series of doses of the suspected antigen at gradually-increasing doses in an attempt to strengthen the patient's tolerance to the antigen in question.

However, notes and records kept in conjunction with immunotherapy treatments have traditionally been hand written, and stored as hard copies. The hard copies require significant storage space in a medical office, and are difficult to backup to safeguard against losses of such hard-copy documents. Further, maintaining and updating hard-copy documents, as well as making the hard-copy documents available to physicians and others at the medical office during appointments with the patients is labor intensive. The hard-copy documents are also limited to containing certain types of information, and are susceptible to pitfalls such as poor penmanship by the author of the hard-copy documents' author(s).

Accordingly, there is a need in the art for a method and system of maintaining information to be used in the performance of immunotherapy treatment of patients. Such a method and system may allow for the inclusion of confirmation information to provide a secondary confirmation of a patient's identity during immunotherapy treatments, and may employ a computer-readable interface such as a barcode system, for example, to minimize the time required to enter and/or retrieve information into/from the system.

### BRIEF SUMMARY

According to one aspect, the subject application involves a method of managing information related to immunotherapy treatment in a computer system is provided. The computer system includes an input peripheral system for reading a computer-readable code and inputting the computer-readable code into the computer system. An antigen having a predetermined concentration is associated with a master code that is computer readable to at least identify the antigen and the concentration of the antigen associated with the master code. An antigen recipe to be administered to the patient during immunotherapy treatment is associated with an antigen recipe code that is computer readable to identify each antigen included in the antigen recipe that is to be administered to the patient. In response to receiving the master code read by the input peripheral system in communication with the computer system, the antigen and the concentration of the antigen are associated with the antigen recipe code.

According to another aspect, the subject application involves a method of managing information related to immunotherapy treatment of a patient in a computer system. The computer system includes an input peripheral system for reading a computer-readable code and inputting the computer-readable code into the computer system. The method includes associating a patient account with a patient code that is computer readable, and receiving the patient code via a portion of the input peripheral system operatively connected to the computer system at an immunotherapy treatment facility. In response to receiving the patient code, a notification indicating arrival of the patient at the immunotherapy treatment facility is transmitted to a remotely-located communication device in communication with the computer system. The notice is presented to alert a technician that the patient is available to receive immunotherapy treatment. In response to receiving the patient code, a picture of the patient is displayed to the technician to allow the technician to confirm an identity of the patient prior to administering the immunotherapy treatment. The method also includes receiving an antigen recipe code read by a portion of the input peripheral system operatively connected to the computer system. The antigen recipe code is associated with an antigen composition administered to the patient during immunotherapy treatment. And the antigen recipe administered during immunotherapy treatment is associated with the patient code.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 shows an illustrative embodiment of master vials used to create an antigen composition of various concentrations in patient vials;

FIGS. 2A and 2B show illustrative embodiments of a front and back side of a patient ID card;

FIG. 3 shows an illustrative embodiment of a computer system for performing an embodiment of a method described herein;

FIG. 4 shows an exemplary flow diagram describing a method of managing information relating to immunotherapy treatments described herein; and

FIG. 5 shows an exemplary flow diagram describing another method of managing information relating to immunotherapy treatments described herein.

### DETAILED DESCRIPTION

Certain terminology is used herein for convenience only and is not to be taken as a limitation on the present invention. Relative language used herein is best understood with reference to the drawings, in which like numerals are used to identify like or similar items. Further, in the drawings, certain features may be shown in somewhat schematic form.

It is also to be noted that the phrase “at least one of”, if used herein, followed by a plurality of members herein means one of the members, or a combination of more than one of the members. For example, the phrase “at least one of a first widget and a second widget” means in the present application: the first widget, the second widget, or the first widget and the second widget. Likewise, “at least one of a first widget, a second widget and a third widget” means in the present application: the first widget, the second widget, the third widget, the first widget and the second widget, the first widget and the third widget, the second widget and the third widget, or the first widget and the second widget and the third widget.

During allergy immunotherapy treatments, gradually increasing doses of a suspected antigen are subcutaneously administered to a patient, thereby gradually building up the immunity of the patient to the antigen over time. The hope is that routine exposure to gradually increasing antigen concentrations will improve the patient's immunity to the antigen.

To begin immunotherapy, a patient initially visits a medical office in response to experiencing an allergic reaction that the patient believes was triggered by a particular substance to which the patient was exposed. The patient identifies to someone at the medical office the particular substance(s) suspected as having caused the allergic reaction. In response, a physician, physician's assistant, nurse, or other person at the medical office (collectively referred to herein as a “technician”) will conduct what will be referred to herein as a “vial test” on the patient. The vial test is used to determine whether the suspected antigen is actually the cause of the allergic reaction, and the concentrations of that antigen the patient can tolerate without a severe allergic reaction requiring medical intervention to address.

During the vial test, and based on the patient's description of the severity of the allergic reaction experienced, a suitably low concentration of the antigen is subcutaneously applied to the patient, who is then monitored for a reaction. If the patient exhibits a severe allergic reaction to the concentration administered, it can be determined that a lower concentration is an appropriate initial concentration for future immunotherapy treatments. Similarly, if the patient exhibits a very minor reaction to the antigen administered during the vial test, a greater concentration than that applied during the vial test can be used as the initial concentration of the antigen for purposes of performing future immunotherapy treatments.

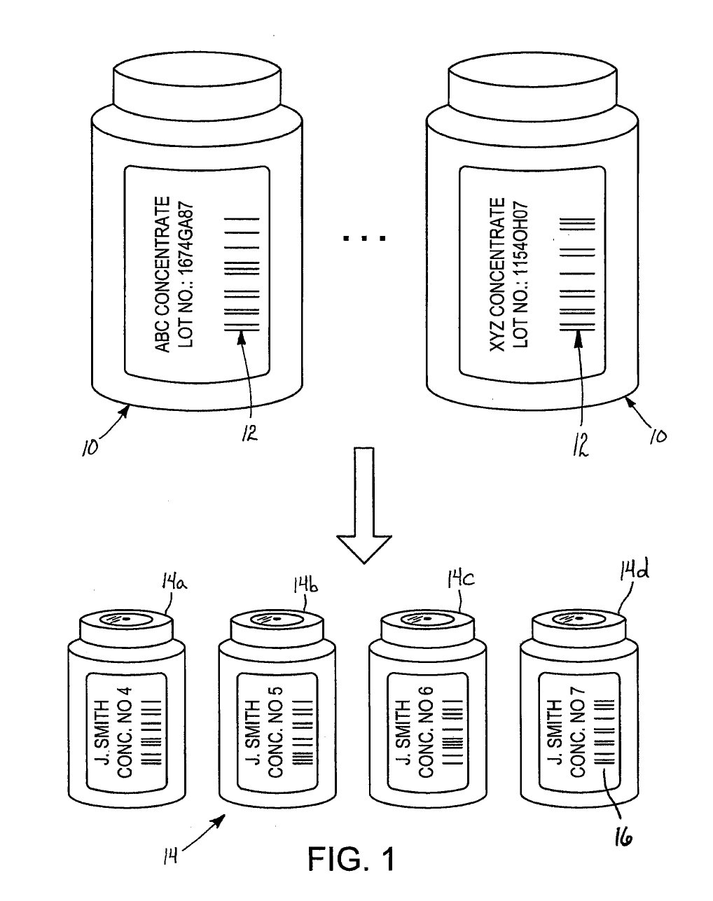

The vial test can also serve to confirm and eliminate suspected antigens from those believed to have possibly caused the allergic reaction experienced by the patient that led to the visit to the medical office. If a patient exhibits no reaction to a suspected antigen, then it can be eliminated from future consideration during subsequent immunotherapy treatments. Thus, the vial test can be utilized to create what allergists refer to as a recipe that includes one or more antigens, and the respective concentration of each antigen, that are to be combined into an antigen composition that is to be subcutaneously administered to the patient during immunotherapy treatments. The antigen composition based on this recipe is stored at gradually decreasing concentrations in a set of patient vials 14 as shown in FIG. 1. A range of antigen composition concentrations are selected for the immunotherapy treatments. For the embodiment shown in FIG. 1 the concentration of the antigen composition in patient vial 14a storing concentration number “4” is greater than the concentration of the antigen composition in patient vial 14b storing concentration number “5”. Likewise, the concentration of the antigen composition in patient vial 14b storing concentration number “5” is greater than the concentration of the antigen composition in patient vial 14c storing concentration number “6”, and so on. To clearly describe the invention herein, and for the embodiment shown in FIG. 1, it has been determined to administer the antigen composition beginning at concentration number “7” and then gradually increase the antigen concentration administered during immunotherapy treatments by progressing on to concentration number “6” once the administration of concentration number “7” has been completed. The administration of the antigen at concentration number “7” can be complete when all of the antigen composition in patient vial 14d has been used, when the patient has shown a desired tolerance improvement to the antigen concentration at concentration number “7” relative to the patient's tolerance at the beginning of the administration of concentration number “7”, or as otherwise determined by the technician involved with the immunotherapy treatments.

Once the suspected antigen(s) and their respective concentrations have been determined, the patient vials 14 storing the desired range of concentrations of the antigen composition are to be prepared. One embodiment of preparing the patient vials 14 includes extracting each antigen in the recipe to be added to the patient vials 14 from the proper master vials 10 storing that antigens at the desired, predetermined concentration called for by the recipe. The master vials 10 store various different concentrations of antigens purchased from a vendor and kept in stock by the medical facility. The master vials 10 themselves can be filled by placing a known quantity of antigen concentrate obtained from a vendor and diluting the known quantity of antigen concentrate to the predetermined concentration for that particular master vial 10. Master vials 10 containing lower concentrations can then be filled by extracting the diluted antigen from the first master vial 10 and further diluting the diluted antigen, or by independently filling the next master vial 10 with a known quantity of the antigen concentrate and diluting just as with the previous master vial 10, but with a greater amount of diluent.

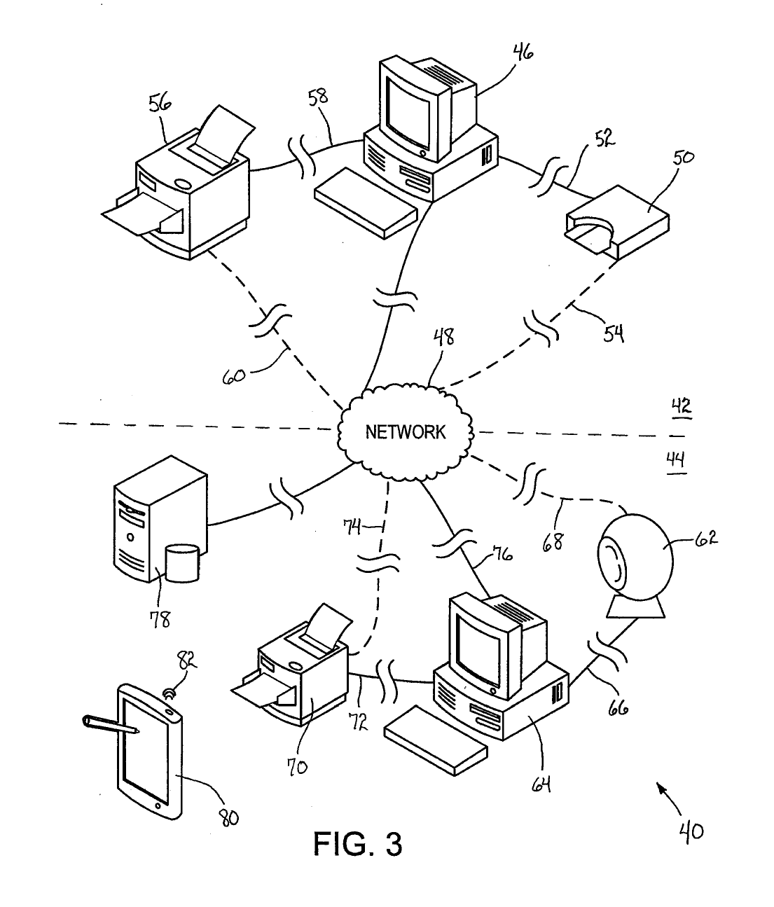

Each master vial 10 can be provided with a computer-readable master code, shown as a one-dimensional barcode 12 in FIG. 1, which represents information about the diluted antigen contained within that master vial 10. Although shown in FIG. 1 and referred to herein as a barcode 12, the master code can be any type of computer-readable form of data that, when read, allows a computer system to identify data associated with the diluted antigen in the master vial 10 to which the master code is provided. For example, other suitable forms of master codes can include a two-dimensional barcode, RFID tag, magnetic storage medium, wireless transmitter module, or any other suitable code that can be interrogated by a computer system 40 (FIG. 3) to allow the computer system 40 to identify information about the master vial to which it is provided and the contents of that master vial 10. The information that can be identified by reading the barcode 12 can include any information relating to the diluted antigen stored in the associated master vial 10, such as the source of the antigen concentrate, lot number, expiration date of the antigen concentrate and/or diluted antigen in the master vial 10, date of manufacture of the antigen concentrate, identity of the antigen, any other information about the antigen concentrate and/or diluted antigen in the master vials 10, or any combination thereof.

The diluted antigens stored in the master vials 10 can then be used as ingredients in preparing the recipes of several different patients. Each patient is likely to require the administration of a unique antigen recipe that includes a combination of different antigens at different concentrations compared to other patients. Thus, unlike the master vials 10 the patient vials 14 store antigen compositions created from recipes that are specific to the patient. The antigen compositions according to the antigen recipe for each patient are prepared by combining the appropriate amounts of diluted antigens having the desired predetermined concentrations from the master vials 10 in a set of patient vials 14. According to one embodiment, the most concentrated of the antigen compositions in the range shown in FIG. 1 to be administered to the patient can be prepared in the patient vial 14a. A portion of that antigen composition can then be extracted from patient vial 14a and placed in the next patient vial 14b in the range along with a diluent to achieve the desired antigen composition concentration for the next patient vial 14b. This process can be repeated by combining a portion of the antigen composition from the patient vial 14b and a suitable diluent in the next patient vial 14c to achieve the desired concentration for that patient vial 14c, and so on until the entire range of concentrations has been prepared for the patient. Other embodiments include combining a suitable amount of diluted antigen from the master vial 10 with a suitable amount of diluent for each of the patient vials 14 individually.

Each patient vial 14 can also be provided with an antigen recipe code, such as barcode 16 shown in FIG. 1. Like the barcode 12 provided as the master code to the master vials 10, the antigen recipe code represents information about the antigen composition contained within its respective patient vial 14. Although shown in FIG. 1 and referred to herein as a barcode 14, the antigen recipe code can be any type of computer-readable form of data that, when read, allows a computer system 40 to identify data associated with the antigen composition in the patient vial 14 to which the antigen recipe code is provided. For example, other suitable forms of antigen recipe codes can include a two-dimensional barcode, RFID tag, magnetic storage medium, wireless transmitter module, or any other suitable code that can be interrogated by a computer system 40 to allow the computer system 40 to identify information about the patient vial 14 to which it is provided and the contents of that patient vial 14. The information that can be identified by reading the barcode 16 can include any information relating to the antigen composition stored in the associated patient vial 14, such as the:

master vial 10 from which each diluted antigen was added to the patient vial 14,

preparation date of each master vial 10 from which each diluted antigen was added to the patient vial 14,

the identity of the person who prepared the master vial 10 from which each diluted antigen was added to the patient vial 14,

source of the antigen concentrate in the master vial 14 from which each diluted antigen was added to the patient vial 14,

lot number of the antigen concentrate in the master vial 10 from which each diluted antigen was added to the patient vial 14,

expiration date of the antigen concentrate, diluted antigen and/or antigen composition,

date of manufacture of the antigen concentrate in the master vial 10 from which each diluted antigen was added to the patient vial 14,

identity of each antigen in the patient vial 14,

the recipe from which the antigen composition is made,

any other information about the antigen concentrate, diluted antigen and/or antigen composition in the patient vials 14, or

any combination thereof.

For the embodiments including master and antigen recipe codes in the form of barcodes 12, 16, respectively, the barcodes 12, 16 can be printed onto a label by a technician in the medical office using a printer as described below and the labels applied to their respective vials 10, 14. Use of the barcodes 12, 16 as the master and antigen recipe codes allows the medical office to create the master and antigen recipe codes locally, without requiring additional hardware that is not commonly found in medical offices.

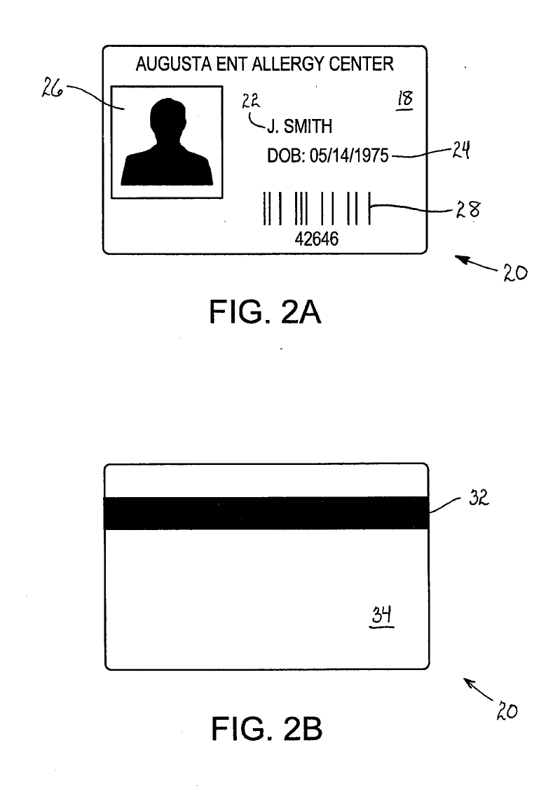

FIG. 2A illustrates an embodiment of a front side 18 of a patient ID card 20 that can be given to the patient and used to identify the patient when the patient visits the medical office for future immunotherapy treatments. As shown, the front side 18 of the patient's ID card 20 includes information about the patient such as the patient's name 22, the patient's date of birth, 24, a photograph 26 of the patient, and a patient code in the form of a barcode 28. The patient's ID card 20 can be associated with a user account stored by, or at least accessible by the computer system 40 such as that described below, and barcode 28, when read by a suitable input peripheral included in an input peripheral system operatively connected to the computer system 40, allows the computer system 40 to retrieve information specific to the patient. For example, a barcode 28 can represent an account number for the patient account that, when read, returns a main page of a graphical user interface, such as a website for example, of the patient account to provide details of the patient's treatment. An alphanumeric display 30 of such an account number, patient ID number, etc. . . . represented by the barcode 28 can also optionally be provided to the patient ID card 20 as a safeguard to ensure proper identification of the patient in the event the barcode 28 is damaged. The alphanumeric display 30 is human readable without the assistance of the computer system 40.

FIG. 2B illustrates an exemplary embodiment of a patient code in the form of a magnetic strip 32 provided to a rear side 34 of the patient ID card 20 that can be read by an input peripheral device operatively connected to the computer system 40 enter the patient code into the computer system 40 from the patient ID card 20. Again, like the master code and the antigen recipe code, the patient code can be embodied in any desired computer-readable form. For example, the patient code can be embodied not only as a barcode 28 or magnetic strip 32, but also, or instead of, a wireless transmitter module, a RFID tag provided to the patient ID card 20, or in any other suitable computer-readable form.

Alternate embodiments can optionally utilize a magnetic strip provided to an existing form of identification already carried by the patient instead of, or in addition to a dedicated patient ID card 20. For example, many states require driver licenses to include such a magnetic strip. The patient account can optionally be associated with information that can be read by an input peripheral device from the magnetic strip provided to the existing form of identification. Examples of other types of identification according to such embodiments can include a credit card or any other card bearing a magnetic strip that can store computer-readable information.

FIG. 3 shows an illustrative embodiment of a computer system 40 for implementing a method of managing information relating to immunotherapy treatments as described herein. The computer system 40 can be viewed as including an administrative side 42 and a clinical side 44. The administrative side 42, or at least a portion thereof, can be disposed at a reception area where patients arriving at the medical office are greeted and await permission to enter a portion of the medical office where immunotherapy treatments are performed. The administrative side 42 and clinical side 44 and not necessarily physically separated from each other, but serve different purposes. The administrative side 42 is primarily concerned with processing patient information, managing financial matters relating to medical treatment of the patient, and gathering and updating patient information in preparation for providing the immunotherapy treatments.

In contrast, the clinical side 44 is primarily focused on the actual subcutaneous administration of the instant compositions to the patient and other medical care offered to the patient during a visit. Thus, personnel working on the administrative side 42 will primarily handle clerical matters while the technicians working on the clinical side 44 will primarily handle the provision of medical care and immunotherapy treatments to the patient.

The portion of the computer system 40 on the administrative side 42 can include one or more computer terminals 46 operatively connected via a network 48 to other portions of the computer system 40. The network 48 includes conventional networking hardware and software such as routers, switches, hubs, wireless transmitters, modems, and any other conventional networking equipment for facilitating communication between computer terminals as is known in the art.

An input peripheral such as a card reader 50 that can read the barcode 28, magnetic strip 32, or any other form of patient code, or combination thereof provided to the patient ID card 20. The card reader 50 is shown operatively connected to the local computer terminal 46 via a wired communication channel 52 represented by a solid line. However, alternate embodiments of the computer system 40 can optionally include a network card reader 50 operatively connected via a communication channel 54, indicated by the broken line, to other portions of the computer system 40 via the network 48 instead of, or in addition to the local, hardwired connection. The card reader 50 can optionally be positioned at a location from where it is accessible to patients in a waiting area or entrance of the medical office. Patients can insert their patient ID card 20 into the card reader 50 upon arriving at the medical office. The card reader 50 reads the barcode 28 or other embodiment of the patient code and, in response, transmits a signal indicating the arrival of the patient at the medical office and the patient's availability to receive immunotherapy treatment.

Other embodiments of the peripheral input device such as a RFID tag reader can optionally read the patient code from an RFID tag provided to the patient ID card 20 or otherwise carried by the patient without requiring the patient to take any affirmative actions. For example, an RFID reader can be positioned adjacent to an entrance to the medical office and can wirelessly interrogate the RFID tag provided to the patient ID card 20 as the patient walks through the entrance. According to such embodiments, the transmission range of the RFID tag reader should be short enough to limit the undesirable interrogation of RFID tags carried by patients outside of the entrance area.

The administrative side 42 of the computer system 40 can also optionally include a printer 56. Like the card reader 50, the printer 56 can be locally connected to the computer terminal 46 via a communication channel 58, connected to other portions of the computer system 40 (including the computer terminal 46) through the network 48 via a communication channel 60 instead of the communication channel 58, or a combination thereof. The printer 56 can be used by personnel on the administrative side 42, and optionally the clinical side 44 of the computer system 40 to print the patient ID card 20 including the barcode 28, and optionally the labels including the master code 12 for the master files 10 and the barcode 16 for the patient vials 14.

The clinical side 44 of the computer system 40 includes at least a barcode scanner 62 or other input peripheral operatively connected to the computer system 40 for reading the particular form of master code and antigen recipe code employed by the medical office. The barcode scanner 62 can be connected locally to a computer terminal 64 provided to the clinical side 44 of the computer system 40 via a communication channel 66, can be network connected to other portions of the computer system 40 as a shared resource via communication channel 68 represented by the broken line, or a combination thereof. The printer 70 on the clinical side 44 can likewise be locally connected to the computer terminal 64 via communication channel 72, connected to the computer terminal 64 in other computer system resources via communication channel 74, or combination thereof. The computer terminal 64 itself can be connected to other computer system resources via the network 48 by communication channel 76, and can optionally communicate with an optional server 78, which includes a computer-readable medium as a centralized storage location for the various types of information managed by the methods discussed herein. The server 78 can optionally store portions of content to be served to other devices included in the computer system 40, such as computer terminals 46, 64, for example to generate the displays discussed herein. The clinical side 44 can also optionally include a portable communication terminal 80 that can communicate with other resources connected to the network 48 via a wireless commute teaching channel 82.

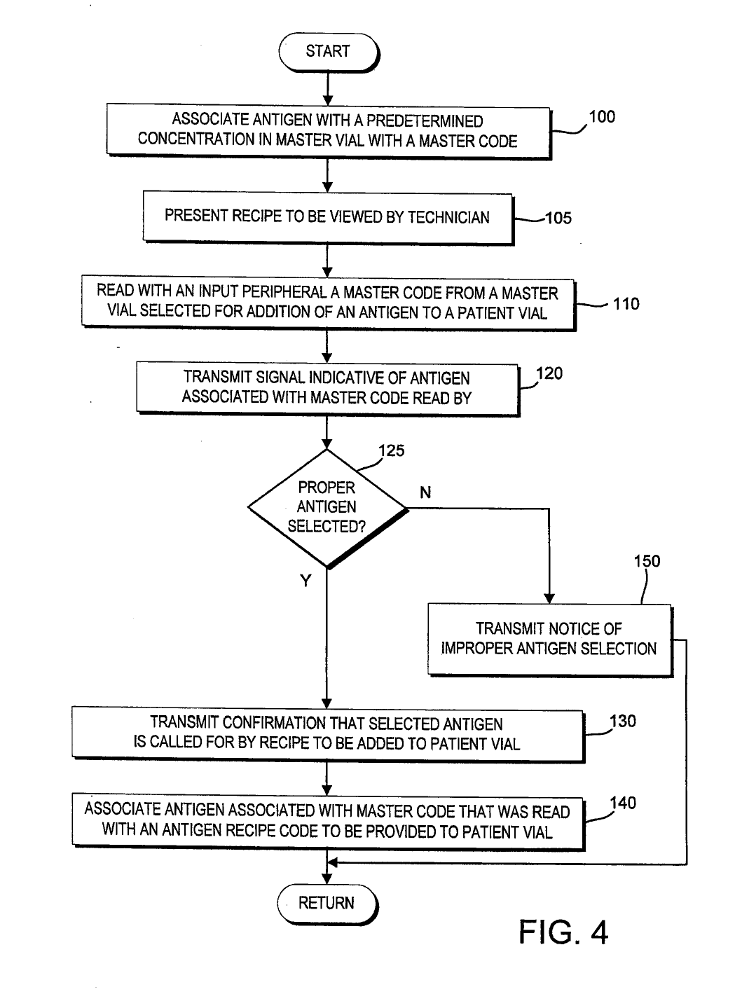

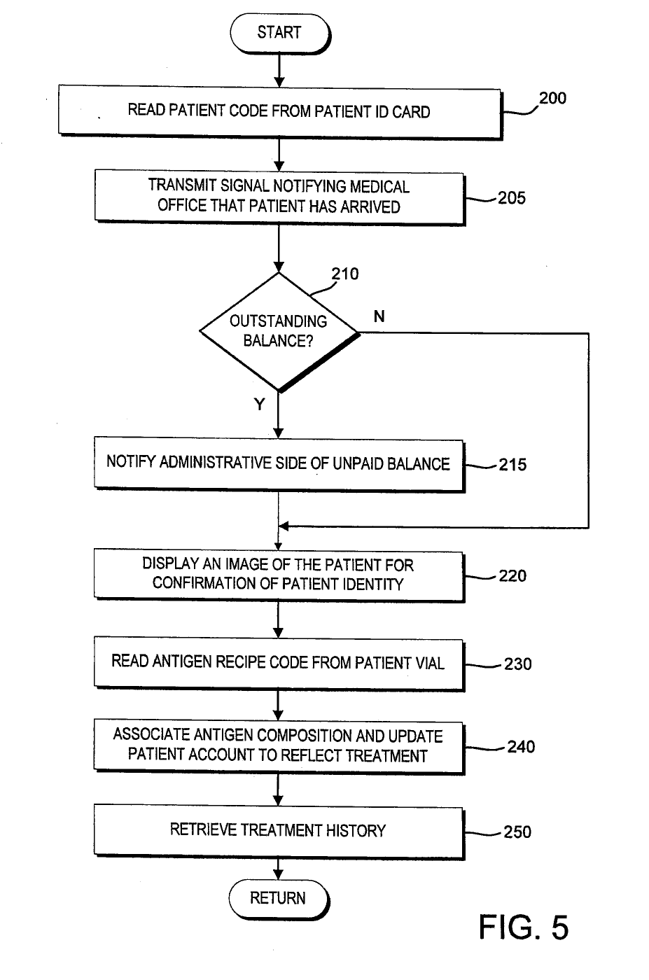

In use, the computer system 40 is operable to perform a method best understood with reference to FIGS. 4 and 5. A technician can fill the master files 10 with their respective antigens as needed by creating a record in a database stored by the server 78 for that master vial 10. The technician can dilute the antigen concentrate down as described above and can generate a label to be applied to the master vial 10, wherein the label comprises a barcode 12 indicative of the contents, and optionally the source of the contents of that master vial 10. Thus the antigen having a predetermined concentration within the master vial 10 is associated by the computer system 40 with the master code 12 applied to that master vial 10 at step 100. The master vials 10 can be filled as needed when their supply dwindles.

The results of the vial test lead to the creation of a recipe for a particular patient. The recipe can optionally be stored in electronic format by a computer-readable medium included within the computer system 40. For such an embodiment, the electronic recipe can be transmitted to the computer terminal 64 where it is to be displayed or otherwise presented at step 105 to a technician for preparation of the patient vials 14. According to alternate embodiments, presentation of the electronic recipe can be performed by printing the recipe with the printer 70, e-mailing the recipe to the technician, or simply displaying the recipe on a display device such as that provided to the portable communication terminal 80 or the computer terminal 64, for example.

As the technician selects the master vials 10 having the antigen concentration called for by the recipe to be added to the patient vial 14, the technician presents to the barcode scanner 62 the barcode 12 on each master vial 10 from which an antigen is to be withdrawn and added to the patient vials 14. The barcode scanner 62 reads the barcode 12 on the master vial 12 at step 110 and transmits a signal indicative of the antigen associated with that barcode 12 at step 120 to indicate the addition of that antigen to the patient vial 14.

For embodiments where the computer terminal 64 presents the recipe to the technician via the computer terminal 64, the signal transmitted by the barcode scanner 62 causes the computer system 40 to compare the antigen associated with the scanned barcode 12 with the recipe at step 125 to determine if a proper antigen master vial 10 has been selected by the technician. If so, the computer terminal 64 can provide an audible, visible, or an audible and visible confirmation to the technician that the antigen selected is correct, and the antigen associated with the barcode 12 is associated with the antigen recipe code to be applied to the patient vial 14 at step 140. For example, the computer terminal 64 can mark the antigen associated with the barcode 12 as having been added to the patient vial 14 by placing a check mark next to that entry of the displayed recipe. The antigen, and optionally the concentration of the antigen and other information relating to the antigen associated with the barcode 12 is to be associated with an antigen recipe code 16 to be provided to the patient vial 14 at step 130.

If it is determined at step 125 that an improper master vial 10 containing an antigen not included in the recipe has been selected by the technician, the computer terminal 64 can optionally present the technician with an audible, visible, or audible and visible notice that the antigen associated with the scanned barcode 12 is not listed in the recipe to be added to the patient vial 14, or is of an incorrect concentration. Such a situation can occur if the technician inadvertently selects the wrong master vial 10 when intending to select another master vial 10 listed in the recipe. This notice can alert the technician to the situation and possibly prevent the incorrect addition of the wrongly selected antigen before such an error occurs.

Once all of the antigens included in the recipe and added to the patient vial 14, the label including antigen recipe code 16 can be printed using the printer 70 provided to the computer system 40 and applied to the corresponding patient vial 14. When the patient account is created, the technician or other person associated with the medical office can access a patient's account and select an option enabling the antigen recipe code 16 to be associated with the patient account, as well as the patient code in the form of the barcode 28. According to one embodiment, this can be accomplished by scanning the antigen recipe code 16 following selection of the option in the patient account that enables the association of the barcode 16 with the barcode 28. Thus, when the barcode 28 is subsequently read by the peripheral input device such as card reader 50, all antigen recipe codes associated with that barcode 28 can be readily accessed via a computer system 40. Further, subsequent scanning of the antigen recipe code 16 provided to the patient vial 14 causes the computer system 40 to retrieve and present the information relating to the antigen composition disposed of in that patient vial 14.

After the patient account has been updated to include an association with each of the antigen recipe codes on their respective patient vials 14, the patient having arrived at the medical office can insert the patient ID card 20 into the card reader 50 at step 200 of FIG. 5. In response to reading the barcode 28 from the patient ID card 20, the card reader 50 transmits a signal at step 205 that provides notice of a patient's arrival at the medical office for immunotherapy treatment. The scanning of the patient ID card 20 by the card reader 50 can optionally replace the formal check-in procedures common to most medical offices. The notice of the patient's arrival at the medical office can optionally be automatically presented by the computer system 40 locally to a staff member on the administrative side 42, to a remotely located communication device included on the clinical side 44 such as the computer terminal 64, the portable communication terminal 80, or both.

The computer system 40 can also check internal records stored electronically on a computer readable medium such as that provided to the server 78, for example, to determine whether there exists information that should be brought to the patient's attention. For instance, at step 210 it can be determined whether the patient's account has an unpaid balance owed to the medical office for a previous visit. If so, the existence of this unpaid balance can be brought to the attention of a staff member on the administrative side 42 to be conveyed to the patient at step 215. If not, the method can proceed without displaying such notice to the administrative side 42.

Also in response to, or at least subsequent to reading the barcode 28 from the patient ID card 20, an image of the patient can be displayed to enable confirmation of the identity of the patient at step 220. For instance, the image of the patient can be a digital photograph stored on the computer-readable memory of the server 78. The digital photograph can be retrieved and transmitted to be displayed on the computer terminal 64, the portable communication terminal 80, or both, to be viewed by the technician that is to administer the antigen during immunotherapy treatment. Thus, two patients with similar names will be unlikely to receive subcutaneous application of the wrong antigen.

For example, the patient vials 14 shown in FIG. 1 list J. Smith as the patient's name. The first initial J. may stand for John, but it can also stand for Jennifer. Further, there could be two patients, one male and one female, each with the same unisex name. If the image of a patient displayed in response to reading the barcode 28 is that of the male patient but the technician has brought the patient vials 14 for the female patient of the same name, the technician will be able to readily determined that those patient vials 14 are not intended for the male patient simply by looking at the displayed image of the patient.

With the patient's identity confirmed, the technician can scan the barcode 16 using the barcode scanner 62 at step 230 and subcutaneously administer the antigen composition within that patient vial 14 as part of the immunotherapy treatment. In response to reading the barcode 16 from the patient vial 14, the computer system 40, at step 240, associates the antigen composition in the patient vial 14 with the barcode 28, and adds an entry in the user account indicating the administration of the antigen composition on the date of the immunotherapy treatment. If, at a later date, it is desired to review the immunotherapy treatment history of a particular patient, the barcode 28 can be read by a card reader 50 or the patient code manually entered to retrieve the records detailing previous immunotherapy treatments of the patient at step 250. The details retrieved can include one or more of: the dates on which each previous immunotherapy treatment was administered, the concentration of the antigen composition administered, the amount of the antigen composition administered, notes describing the reaction exhibited by the patient in response to the subcutaneous administering of the antigen composition, or any other information relevant to the immunotherapy treatment of the patient.

Illustrative embodiments have been described, hereinabove. It will be apparent to those skilled in the art that the above devices and methods may incorporate changes and modifications without departing from the general scope of this invention. It is intended to include all such modifications and alterations within the scope of the present invention. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method of managing information related to immunotherapy treatment in a computer system, the computer system comprising an input peripheral system for reading a computer-readable code and inputting the computer-readable code into the computer system, the method comprising:
associating an antigen having a predetermined concentration with a master code that is computer readable, said master code being readable to at least identify the antigen and the concentration of the antigen associated with the master code;
associating an antigen recipe to be administered to the patient during immunotherapy treatment with an antigen recipe code, the antigen recipe code being computer readable to identify each antigen included in the antigen recipe that is to be administered to the patient; and
in response to receiving the master code read by the input peripheral system in communication with the computer system, associating the antigen and the concentration of the antigen with the antigen recipe code.

2. The method of claim 1 further comprising:
associating each of a plurality of other antigens with a unique master code;
in response to receiving the unique master code associated with each of the other antigens read by the input peripheral system in communication with the computer system, associating each of the other antigens with the antigen recipe code, wherein
in response to receiving the antigen recipe code read by the input peripheral system in communication with the computer system, presenting each of the antigen and the other antigens included in the antigen recipe to be viewed by a technician.

3. The method of claim 2 further comprising:
presenting a desired recipe to a technician, the desired recipe including each of the antigen and the plurality of other antigens to be added to a vial for storing the antigen recipe;
transmitting a confirmation signal to the technician indicating that the master code and the unique master codes have been read in response to receiving the master code and the unique master code associated with each of the other antigens; and
transmitting an alert signal that is different than the confirmation signal in response to receiving a master code associated with an unexpected antigen that is absent from the desired recipe.

4. The method of claim 1, wherein each of the antigen and the plurality of other antigens represent different types of substances suspected of initiating an allergic reaction by the patient.

5. The method of claim 1, wherein the antigen comprises a combination of an antigen concentrate received from a vendor and a suitable amount of a diluent to dilute the antigen to the predetermined concentration.

6. The method of claim 1 further comprising:
associating the patient with a patient code, the patient code being computer readable via the input peripheral system to identify the patient; and
associating the antigen recipe code with the patient code.

7. The method of claim 6, wherein each of the patient code, the master code and the antigen recipe code are each independently selected to be a bar code, a RFID code or an RFID code.

8. The method of claim 6 further comprising displaying a picture of the patient to be viewed by the technician in response to receiving the patient code read by the input peripheral system for confirming an identity of the patient.

9. The method of claim 8, wherein the picture of the patient is displayed to be viewed by the technician on a computer terminal included in the computer system, said computer terminal being remotely located from a reader included in the input peripheral system used to read the patient code.

10. A method of managing information related to immunotherapy treatment of a patient in a computer system, the computer system comprising an input peripheral system for reading a computer-readable code and inputting the computer-readable code into the computer system, the method comprising:
associating a patient account with a patient code that is computer readable;
receiving the patient code via a portion of the input peripheral system operatively connected to the computer system at an immunotherapy treatment facility;
in response to receiving the patient code, transmitting a notification indicating arrival of the patient at the immunotherapy treatment facility to a remotely-located communication device in communication with the computer system, said notice being presented to alert a technician that the patient is available to receive immunotherapy treatment;
in response to receiving the patient code, displaying a picture of the patient to the technician to allow the technician to confirm an identity of the patient prior to administering the immunotherapy treatment;
receiving an antigen recipe code read by a portion of the input peripheral system operatively connected to the computer system, the antigen recipe code being associated with an antigen composition administered to the patient during immunotherapy treatment; and
associating the antigen recipe administered during immunotherapy treatment with the patient code.

11. The method of claim 10 further comprising issuing a notification that the patient has an unpaid balance remaining to be paid for a prior immunotherapy treatment.

12. The method of claim 11, wherein the notification is displayed by a locally-located computer station relative to the portion of the input peripheral system that read the patient code.

13. The method of claim 10, wherein the patient code is represented by a barcode printed on a patient identification card and the portion of the input peripheral system includes a barcode reader.

14. The method of claim 10, wherein the patient code is stored in a computer-readable format by a magnetic strip provided on a patient identification card and the portion of the input peripheral system includes a magnetic strip reader.

15. The method of claim 10, wherein the patient code is stored by a RFID circuit provided on a patient identification card and the portion of the input peripheral system includes a RFID reader.

16. The method of claim 10 further comprising presenting a composition of the antigen recipe to the technician in response to receiving the patient code.
